(19) United States
(12) Patent Application Publication
(10) Pub. No.: US 2026/0264405 A1
(43) Pub. Date: Sep. 10, 2026

(54) MANUFACTURING METHOD OF LIQUID DISCHARGE HEAD AND LIQUID DISCHARGE HEAD

(71) Applicant: SEIKO EPSON CORPORATION, Tokyo (JP)

(72) Inventors: Shohei MIZUTA, MATSUMOTO-SHI (JP); Takanori HAMA, OKAYA-SHI (JP); Tsubasa MARUYAMA, SHIOJIRI-SHI (JP); Hiroyuki FUTAKI, AZUMINO-SHI (JP); Masanori MIKOSHIBA, SHIMOSUWA-MACHI (JP)

(21) Appl. No.: 19/556,663

(22) Filed: Mar. 4, 2026

(30) Foreign Application Priority Data
Mar. 6, 2025 (JP) 2025-035229

(51) Int. Cl. B41J 2/16; B41J 2/14

(52) U.S. Cl. CPC B41J 2/162; B41J 2/14233; B41J 2/1433; B41J 2/1628; B41J 2/1642; B41J 2/1646; B41J 2002/1425; B41J 2202/03

(57) ABSTRACT

A manufacturing method of a liquid discharge head includes forming an insulating film at a first surface of a substrate formed of single crystal silicon, forming a first layer formed of polycrystalline silicon on the insulating film by deposition, and forming, at the first layer, a first recessed portion that serves as a first nozzle, the first recessed portion having a bottom surface that is the insulating film. In addition, the liquid discharge head includes a first layer formed of polycrystalline silicon, a second layer formed of single crystal silicon, an insulating film provided between the first layer and the second layer, a first nozzle disposed at the first layer, and a second nozzle disposed at the second layer, the second nozzle penetrating the first nozzle through an opening of the insulating film.

The present application is based on, and claims priority from JP Application Serial Number 2025-035229, filed Mar. 6, 2025, the disclosure of which is hereby incorporated by reference herein in its entirety.

### BACKGROUND

### 1. Technical Field

The present disclosure relates to a manufacturing method of a liquid discharge head and a liquid discharge head.

### 2. Related Art

A liquid discharge apparatus including a liquid discharge head for discharging a liquid such as ink onto a medium such as printing paper is proposed in the related art. The liquid discharge head generally includes a nozzle plate in which a plurality of nozzle holes for discharging an ink droplet are formed, a pressure chamber that communicates with the nozzle plate, and a driving element that applies pressure to the pressure chamber. The pressure of the pressure chamber changes due to driving of the driving element, and the ink droplet is discharged from the nozzle hole.

A nozzle described in JP-A-2010-240852 is configured by a so-called two-stage nozzle including a first nozzle on a liquid discharging side and a second nozzle on a liquid supply side. In manufacturing the nozzle, the first nozzle is formed at one surface of a silicon substrate by dry etching, and then the second nozzle is formed at the other surface of the silicon substrate by dry etching.

In the related art, the first nozzle is formed at one surface of one silicon substrate, and the second nozzle is formed at the other surface of the silicon substrate. In this case, for example, an error between a predicted etching rate and an actual etching rate may cause a length of the first nozzle to deviate from an ideal value or may cause individual differences in the length of the first nozzle. The length of the first nozzle is greatly related to discharging performance. Therefore, when the length of the first nozzle deviates significantly from the ideal value, the discharging performance may be reduced.

### SUMMARY

A manufacturing method of a liquid discharge head according to a suitable aspect of the present disclosure includes forming an insulating film at a first surface of a substrate formed of single crystal silicon, forming a first layer formed of polycrystalline silicon on the insulating film by deposition, and forming, at the first layer, a first recessed portion that serves as a first nozzle, the first recessed portion having a bottom surface that is the insulating film.

A liquid discharge head according to a suitable aspect of the present disclosure includes a first layer formed of polycrystalline silicon, a second layer formed of single crystal silicon, an insulating film provided between the first layer and the second layer, a first nozzle disposed at the first layer, and a second nozzle disposed at the second layer, the second nozzle penetrating the first nozzle through an opening of the insulating film.

### BRIEF DESCRIPTION OF THE DRAWINGS

FIG. 1 is a schematic diagram illustrating a configuration of a liquid discharge apparatus according to a first embodiment.

FIG. 2 is an exploded perspective diagram of a liquid discharge head shown in FIG. 1.

FIG. 3 is a cross-sectional diagram of a part of the liquid discharge head shown in FIG. 1.

FIG. 4 is an enlarged diagram of a vibration plate and a piezoelectric element shown in FIG. 3.

FIG. 5 is an enlarged diagram of a nozzle of a nozzle plate shown in FIG. 3.

FIG. 6 is a diagram showing a flow of a manufacturing method of the nozzle plate according to the first embodiment.

FIGS. 7A, 7B, and 7C are diagrams for describing the manufacturing method of the nozzle plate of FIG. 6.

FIGS. 8A and 8B are diagrams for describing the manufacturing method of the nozzle plate of FIG. 6.

FIG. 9 is a cross-sectional diagram illustrating a nozzle of a nozzle plate according to a second embodiment.

FIG. 10 is a cross-sectional diagram illustrating a nozzle of a nozzle plate according to a third embodiment.

### DESCRIPTION OF EMBODIMENTS

A description will be given below of preferred embodiments according to the present disclosure with reference to the attached drawings. The dimensions or scale of each part in the drawings may differ from actual dimensions or scale as appropriate and some portions are shown schematically for ease of understanding. In addition, the scope of the present disclosure is not limited to these forms unless specifically described in the following description to limit the present disclosure. In addition, “element β on element γ” is not limited to configurations in which element γ and element β are in direct contact with each other, but also includes configurations in which element γ and element β are not in direct contact with each other. In addition, “element α and element β are laminated” means simply that element α and element β are lined up in the vertical direction and it does not matter whether element α and element β are in direct contact with each other.

### 1. First Embodiment

### 1-1. Overall Configuration of Liquid Discharge Apparatus 100

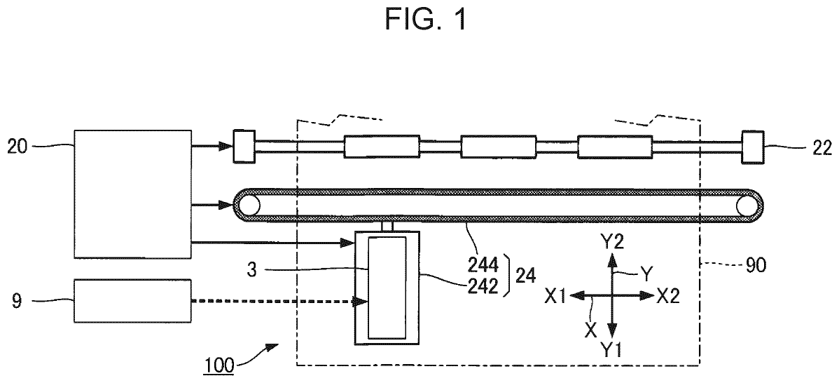

FIG. 1 is a schematic diagram illustrating a configuration of a liquid discharge apparatus 100 according to a first embodiment. Below, for convenience of description, a description will be given using, as appropriate, the X-axis, Y-axis, and Z-axis, which are mutually orthogonal. In addition, one direction along the X-axis is denoted as the X1 direction and the direction opposite to the X1 direction is denoted as the X2 direction. Similarly, one direction along the Y-axis is denoted as the Y1 direction and the direction opposite to the Y1 direction is denoted as the Y2 direction. One direction along the Z-axis is denoted as the Z1 direction and the direction opposite to the Z1 direction is denoted as the Z2 direction. The view in the direction along the Z-axis is called the “plan view”. The Z-axis is typically a vertical axis. The Z2 direction is the upper side and the Z1 direction is the lower side. However, the Z-axis does not have to be the vertical axis. In addition, the X-axis, Y-axis, and Z-axis are typically mutually orthogonal, but may intersect at, for example, angles within a range of 80° or more and 100° or less without being limited thereto.

The liquid discharge apparatus 100 illustrated in FIG. 1 is an ink jet type printing apparatus that discharges an ink, which is an example of a liquid, onto a medium 90. The medium 90 is typically printing paper, but a printing target of any material such as a resin film or fabric may be used as the medium 90. As illustrated in FIG. 1, a liquid container 9 that stores an ink is installed in the liquid discharge apparatus 100. For example, a cartridge that is attachable to and detachable from the liquid discharge apparatus 100, a bag-shaped ink pack formed by a flexible film, or an ink tank that can be replenished with an ink is used as a liquid container 9.

The liquid discharge apparatus 100 includes a control unit 20, a medium transport mechanism 22, a movement mechanism 24, and a liquid discharge head 3. The control unit 20 includes, for example, one or a plurality of processing circuits such as a central processing unit (CPU) or a field programmable gate array (FPGA), and one or a plurality of storage circuits such as a semiconductor memory, and comprehensively controls each element of the liquid discharge apparatus 100.

The medium transport mechanism 22 transports the medium 90 in a direction along the Y-axis under the control of the control unit 20. In addition, the movement mechanism 24 reciprocates the liquid discharge head 3 along the X-axis under the control of the control unit 20. The movement mechanism 24 is provided with an approximately box-shaped transport body 242 that accommodates the liquid discharge head 3, and a transport belt 244 to which the transport body 242 is fixed. It is also possible to adopt a configuration in which a plurality of liquid discharge heads 3 are mounted on the transport body 242, or a configuration in which the liquid container 9 is mounted on the transport body 242 together with the liquid discharge head 3.

The liquid discharge head 3 discharges ink supplied from the liquid container 9 from a plurality of nozzles onto the medium 90 under the control of the control unit 20. In parallel with the transport of the medium 90 by the medium transport mechanism 22 and the repeated reciprocating of the transport body 242, each of the liquid discharge heads 3 discharges ink droplets onto the medium 90, thereby forming an image on the surface of the medium 90.

The liquid discharge apparatus 100 is a serial head type in which the liquid discharge head 3 reciprocates above the medium 90. However, the liquid discharge apparatus 100 may be a line head type in which the liquid discharge head 3 is fixed.

### 1-2. Overall Configuration of Liquid Discharge Head 3

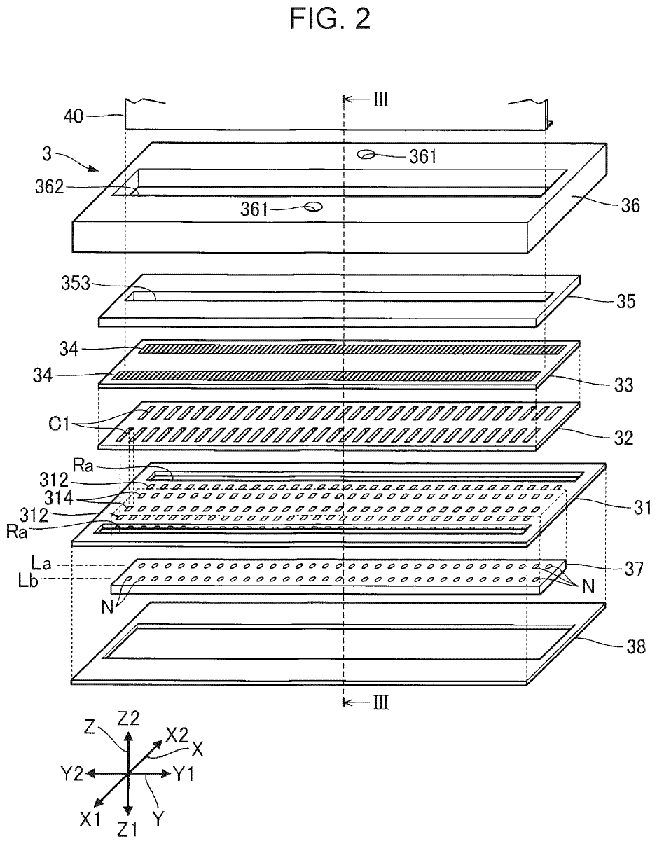

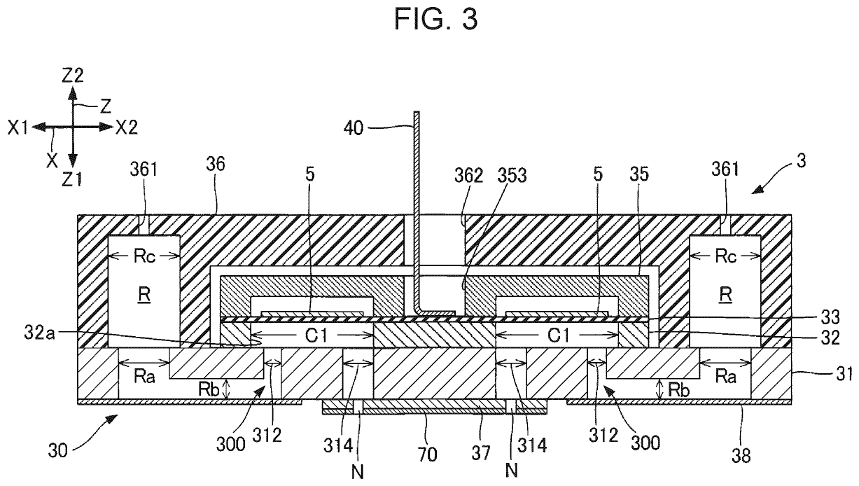

FIG. 2 is an exploded perspective diagram of the liquid discharge head 3 shown in FIG. 1. FIG. 3 is a cross-sectional diagram of a part of the liquid discharge head 3 shown in FIG. 1 taken along the line III-III in FIG. 2. The cross-section shown in FIG. 3 is parallel to the X-Z plane. In addition, the Z-axis extends along a discharging direction of the ink by the liquid discharge head 3.

As illustrated in FIG. 2, the liquid discharge head 3 is provided with a plurality of nozzles N arrayed along the Y-axis. The plurality of nozzles N in the first embodiment are divided into a first row La and a second row Lb arranged side by side at intervals along the X-axis. Each of the first row La and the second row Lb is a collection of a plurality of nozzles N arrayed linearly along the Y-axis. The liquid discharge head 3 has a structure in which elements related to each nozzle N in the first row La and elements related to each nozzle N in the second row Lb are arranged in an approximately plane-symmetrical manner. In the following description, the elements corresponding to the first row La will be mainly described and the description of the elements corresponding to the second row Lb will not be repeated, as appropriate.

As illustrated in FIG. 2 and FIG. 3, the liquid discharge head 3 is provided with a flow path forming substrate 31, a pressure chamber substrate 32, a vibration plate 33, a nozzle plate 37, a vibration absorber 38, a plurality of piezoelectric elements 5, a sealing body 35, a housing portion 36, and a wiring substrate 40. Each of the flow path forming substrate 31, the pressure chamber substrate 32, the vibration plate 33, the nozzle plate 37, the vibration absorber 38, the sealing body 35, and the housing portion 36 is a long plate-like member along the Y-axis. In addition, the nozzle plate 37, the flow path forming substrate 31, the pressure chamber substrate 32, the vibration plate 33, and the sealing body 35 are lined up in this order in the Z2 direction.

The nozzle plate 37 is a plate-like member in which a plurality of nozzles N are formed. Each of the plurality of nozzles N is a through-hole for discharging the ink. The nozzle plate 37 is bonded to the Z1-direction surface of the flow path forming substrate 31, for example, by an adhesive.

The flow path forming substrate 31 forms flow paths through which ink flows. Specifically, the flow path forming substrate 31 is formed with spaces Ra, relay liquid chambers Rb, a plurality of supply flow paths 312, and a plurality of communication flow paths 314. The spaces Ra are elongated openings formed along the Y-axis. Each of the supply flow paths 312 and the communication flow paths 314 is a through-hole formed for each nozzle N. Each of the communication flow paths 314 overlaps with a corresponding nozzle N in the plan view from the Z1 direction. The relay liquid chambers Rb are elongated spaces formed along the Y-axis across the plurality of nozzles N and cause the spaces Ra and the plurality of supply flow paths 312 to communicate with each other. The pressure chamber substrate 32 is bonded to the Z2 direction surface of the flow path forming substrate 31 using an adhesive.

The pressure chamber substrate 32 is formed with a plurality of pressure chambers C1. The ink discharged from the nozzles N is stored in the pressure chambers C1. The pressure chambers C1 are positioned between the nozzle plate 37 and the vibration plate 33 and are spaces formed by inner wall surfaces 32a of the pressure chamber substrate 32. The pressure chambers C1 are formed for each nozzle N. The pressure chambers C1 are elongated spaces provided to extend in the X1 direction. The plurality of pressure chambers C1 are lined up along the Y-axis. Each of the pressure chambers C1 communicates with the communication flow paths 314 and the supply flow paths 312. Accordingly, the pressure chambers C1 communicate with the nozzles N via the communication flow paths 314 and also communicate with the spaces Ra via the supply flow paths 312 and the relay liquid chambers Rb.

The flow path forming substrate 31 and the pressure chamber substrate 32 are manufactured by, for example, processing a silicon (Si) substrate using a semiconductor manufacturing technology such as photolithography and etching. However, a known material and a manufacturing method may be appropriately adopted for manufacturing the flow path forming substrate 31 and the pressure chamber substrate 32.

The vibration plate 33 is coupled to the surface of the pressure chamber substrate 32 opposite to the flow path forming substrate 31. The vibration plate 33 is disposed over the pressure chambers C1 and is elastically deformable. The vibration plate 33 is a plate-like member formed in a long rectangular shape along the Y-axis in the plan view. The vibration plate 33 and the pressure chamber substrate 32 may be integrally configured or may be configured as separate bodies and bonded using an adhesive or the like.

The piezoelectric elements 5 are formed on the surface of the vibration plate 33 on the opposite side to the pressure chambers C1. The piezoelectric elements 5 are provided for each of the pressure chambers C1. The piezoelectric elements 5 are elongated along the X-axis in the plan view. The piezoelectric element 5 is a driving element that applies pressure to the ink in the pressure chamber C1.

The sealing body 35 is bonded to the vibration plate 33, for example, by an adhesive. The sealing body 35 is a structure that protects the plurality of piezoelectric elements 5 and reinforces the mechanical strength of the pressure chamber substrate 32 and the vibration plate 33. The sealing body 35 has recesses formed at the surface facing the vibration plate 33. The plurality of piezoelectric elements 5 are accommodated inside the recesses. In addition, the sealing body 35 also has a space 353 through which the wiring substrate 40 is inserted.

The housing portion 36 is bonded to the flow path forming substrate 31, for example, by an adhesive. The housing portion 36 is a case for storing ink to be supplied to the plurality of pressure chambers C1. The housing portion 36 is formed, for example, by injection molding a resin material. The housing portion 36 is formed with spaces Rc, supply ports 361, and a space 362. The supply ports 361 are conduits through which ink is supplied from the liquid container 9 and which communicate with the spaces Rc. The spaces Rc communicate with the spaces Ra of the flow path forming substrate 31. The spaces formed by the spaces Rc and the spaces Ra function as liquid storage chambers R that store ink to be supplied to the plurality of pressure chambers C1. The ink supplied from the liquid container 9 and passed through the supply ports 361 is stored in the liquid storage chambers R. The ink stored in the liquid storage chambers R branches from the relay liquid chambers Rb to each supply flow path 312 and is supplied in parallel to the plurality of pressure chambers C1. In addition, the space 362 also overlaps with the space 353 of the sealing body 35 in the plan view. The wiring substrate 40 is inserted into the space 353 and the space 362.

The wiring substrate 40 is coupled to the vibration plate 33. The wiring substrate 40 is a mounting component at which a plurality of wirings are formed for electrically coupling the control unit 20 and the liquid discharge head 3. For example, a flexible substrate such as a flexible printed circuit (FPC) or a flexible flat cable (FFC) is suitably adopted for the wiring substrate 40. A driving voltage and a reference voltage for driving the piezoelectric elements 5 are supplied to each of the piezoelectric elements 5 from the wiring substrate 40.

In addition, the vibration absorber 38 is bonded, for example, by an adhesive, to the surface of the flow path forming substrate 31 in the Z1 direction. The vibration absorber 38 is a flexible film that forms the wall surface of the spaces Ra and supplies pressure fluctuations of the ink in the liquid storage chambers R.

In this liquid discharge head 3, when the piezoelectric elements 5 are flexed and deformed by applying a voltage, the vibration plate 33 is flexed and deformed, that is, vibrated, in a direction that reduces the volume of the pressure chambers C1. As a result, the pressure in the pressure chambers C1 changes, and the ink in the pressure chambers C1 is discharged from the nozzle N. The piezoelectric elements 5 return to the original position after the ink is discharged.

In addition, the liquid discharge head 3 is provided with all of each of the elements shown in FIG. 3, but the components of the liquid discharge head 3 do not need to include every element, and additional elements may be provided.

### 1-3. Vibration Plate 33 and Piezoelectric Element 5

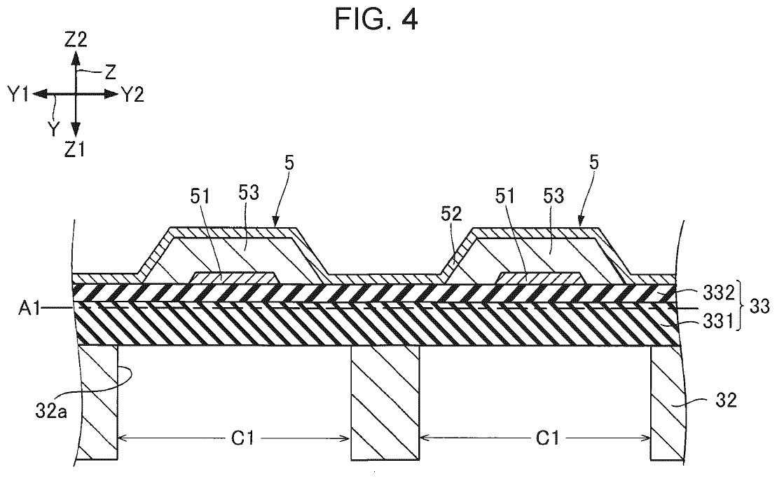

FIG. 4 is an enlarged diagram showing the vibration plate 33 and the piezoelectric element 5 of FIG. 3. The cross-section shown in FIG. 4 is a cross-section parallel to the Y-Z plane.

As shown in FIG. 4, the piezoelectric element 5 mainly includes a lower electrode 51, a piezoelectric layer 53, and an upper electrode 52. The lower electrode 51, the piezoelectric layer 53, and the upper electrode 52 are laminated in the direction along the Z-axis, which is the laminating direction.

The lower electrode 51 is provided above the vibration plate 33. The lower electrode 51 is an individual electrode provided for each piezoelectric element 5. A driving voltage in which a voltage fluctuates is applied to the lower electrode 51. The lower electrode 51 is elongated along the X-axis. The plurality of lower electrodes 51 are arrayed along the Y-axis at intervals. The lower electrode 51 includes, for example, a conductive material such as platinum (Pt). In addition, a thickness of the lower electrode 51 along the Z-axis is not particularly limited, but is, for example, 50 nm or more and 120 nm or less.

The piezoelectric layer 53 is provided above the lower electrode 51. The piezoelectric layer 53 is, for example, a band-shaped dielectric film that is continuous along the Y-axis across the plurality of piezoelectric elements 5 and is separated for each piezoelectric element 5 by forming a plurality of notches. The piezoelectric layer 53 is composed of a piezoelectric material having a perovskite-type crystal structure. Examples of the piezoelectric material include lead titanate (PbTiO₃), lead zirconate titanate (PZT: Pb(Zr, Ti)O₃), lead zirconate (PbZrO₃), lead titanate lanthanum ((Pb, La), TiO₃), lead zirconate titanate lanthanum ((Pb, La)(Zr, Ti)O₃), lead zirconate titanate niobate (Pb(Zr, Ti, Nb)O₃), lead zirconate titanate magnesium niobate (Pb(Zr, Ti)(Mg, Nb)O₃), and potassium sodium niobate (KNN). The piezoelectric layer 53 may contain a small amount of other elements such as impurities. In addition, a thickness of the piezoelectric layer 53 along the Z-axis is not particularly limited, but is, for example, 300 nm or more and 1500 nm or less.

The upper electrode 52 is provided above the piezoelectric layer 53. The upper electrode 52 is a strip-shaped common electrode that extends along the Y-axis so as to be continuous across the plurality of the piezoelectric elements 5. A constant reference voltage is applied to the upper electrode 52. The upper electrode 52 includes, for example, a conductive material such as iridium (Ir). In addition, a thickness of the upper electrode 52 along the Z-axis is not particularly limited, but is, for example, 50 nm or more and 120 nm or less.

A voltage corresponding to a difference between the reference voltage applied to the upper electrode 52 and the driving voltage applied to the lower electrode 51 is applied to the piezoelectric layer 53. By applying a voltage between the lower electrode 51 and the upper electrode 52, the piezoelectric layer 53 deforms such that the piezoelectric element 5 flexes and deforms, that is, vibrates.

The vibration plate 33 is vibrated by the driving of the piezoelectric elements 5. In the illustrated example, the vibration plate 33 is formed of a laminate including a first vibration layer 331 and a second vibration layer 332. The first vibration layer 331 contacts the pressure chamber substrate 32. The second vibration layer 332 is disposed above the first vibration layer 331. The first vibration layer 331 is formed of an elastic material such as silicon oxide (SiOₓ). The second vibration layer 332 is formed of an insulating material such as zirconium oxide (ZrOₓ). The first vibration layer 331 is formed, for example, by thermally oxidizing a part of the pressure chamber substrate 32. The second vibration layer 332 is formed, for example, by a known film forming technique such as sputtering. The vibration plate 33 may be formed of one layer or formed of three or more layers.

### 1-4. Nozzle Plate 37

FIG. 5 is an enlarged diagram of the nozzle N of the nozzle plate 37 shown in FIG. 3.

The nozzle plate 37 shown in FIG. 5 includes a first layer 371, a substrate 372, and an insulating film 373. The first layer 371, the insulating film 373, and the substrate 372 are laminated in this order in the Z2 direction.

The first layer 371 is composed of a material different from the substrate 372. In the present embodiment, the first layer 371 is composed of polycrystalline silicon. In addition, the first layer 371 may contain a component other than silicon. In addition, the first layer 371 may be composed of, for example, amorphous silicon, aluminum oxide (Al₂O₃), silicon carbide (SiC), gallium nitride (GaN), or polyimide. In addition, a thickness of the first layer 371 along the Z-axis is larger than a thickness of the insulating film 373 along the Z-axis. A thickness of the first layer 371 is, for example, 5 μm or more and 20 μm or less. In addition, the first layer 371 has a nozzle surface 3710. The nozzle surface 3710 is a lower surface of the nozzle plate 37 and is a discharging surface from which an ink droplet is discharged from the nozzle N.

The substrate 372 corresponds to a “second layer”. The substrate 372 is composed of silicon. Specifically, the substrate 372 is composed of single crystal silicon. In addition, the substrate 372 may contain or may not contain impurities, and may be n-type silicon or p-type silicon. A thickness of the substrate 372 along the Z-axis is larger than a thickness of the insulating film 373 along the Z-axis. A thickness of the substrate 372 along the Z-axis is larger than a thickness of the first layer 371 along the Z-axis, but may be equal to or less than the thickness of the first layer 371 along the Z-axis. A thickness of the substrate 372 is, for example, 30 μm or more and 80 μm or less. In addition, the substrate 372 has a first surface 3721 and a second surface 3722 on a side opposite to the first surface 3721. Each of the first surface 3721 and the second surface 3722 is a main surface along the X-Y plane. The first surface 3721 is in contact with the insulating film 373. The second surface 3722 is an upper surface of the nozzle plate 37 and is a surface in contact with the flow path forming substrate 31.

The insulating film 373 is provided between the first layer 371 and the substrate 372. The insulating film 373 has insulating properties and is composed of a material different from each of the substrate 372 and the first layer 371. The insulating film 373 is composed of, for example, silicon oxide. The insulating film 373 may be composed of silicon oxynitride, silicon nitride, or the like. A thickness of the insulating film 373 is, for example, 0.2 μm or more and 0.8 μm or less.

A plurality of nozzles N are formed in the nozzle plate 37. In FIG. 5, any one nozzle N of the plurality of nozzles N is shown.

The nozzle N is a through-hole formed in the nozzle plate 37. The nozzle N includes a first nozzle N1, a second nozzle N2, and a boundary portion N3. The first nozzle N1 is a through-hole formed in the first layer 371. The second nozzle N2 is a through-hole formed in the substrate 372. The boundary portion N3 is a through-hole formed in the insulating film 373.

The nozzle N is a so-called two-stage nozzle. The first nozzle N1 and the second nozzle N2 are arranged in this order in the Z2 direction and are connected to each other through the boundary portion N3. Each of the first nozzle N1 and the second nozzle N2 extends along the Z-axis. In addition, the boundary portion N3 may be regarded as a part of the first nozzle N1 or a part of the second nozzle N2.

A shape of each of cross sections of the first nozzle N1, the second nozzle N2, and the boundary portion N3 is circular. Each of the first nozzle N1, the second nozzle N2, and the boundary portion N3 has a cylindrical shape with an axis A0 as a central axis and is provided coaxially. In addition, in the example shown in the drawing, a length L1 of the first nozzle N1 along the Z-axis is shorter than a length L2 of the second nozzle N2 along the Z-axis, but may be equal to or longer than the length L2 of the second nozzle N2 along the Z-axis.

A cross-sectional area of the first nozzle N1 is smaller than a cross-sectional area of the second nozzle N2. That is, a diameter of the second nozzle N2 is larger than a diameter of the first nozzle N1. Therefore, it is possible to discharge a fine ink droplet and to improve landing accuracy of the ink droplet, as compared to a case in which the diameter of the nozzle N is constant.

The first nozzle N1 is a through-hole composed of an inner wall surface 3713. The first nozzle N1 has a discharging-side opening Na for discharging the ink droplet. The discharging-side opening Na is an opening end that opens to the nozzle surface 3710. In addition, the second nozzle N2 is a through-hole composed of an inner wall surface 3723. The second nozzle N2 has a supplying-side opening Nb for supplying the ink to the nozzle N. The supplying-side opening Nb is an opening end that opens to the second surface 3722. The supplying-side opening Nb is also a boundary portion between the communication flow path 314 of the flow path forming substrate 31 and the nozzle N. A length along the Z-axis from the supplying-side opening Nb to the discharging-side opening Na is a total length of the nozzle N. In addition, the boundary portion N3 is a through-hole composed of an inner wall surface 3733. The boundary portion N3 communicates with each of the first nozzle N1 and the second nozzle N2. A length L3 of the boundary portion N3 along the Z-axis direction is shorter than each of the lengths L1 and L2.

In the present embodiment, each of cross-sectional areas of the first nozzle N1, the second nozzle N2, and the boundary portion N3 is constant. The cross-sectional area of the first nozzle N1 is the smallest, and the cross-sectional areas of the first nozzle N1, the second nozzle N2, and the boundary portion N3 are large in this order. A diameter of the first nozzle N1 is, for example, 20 μm or more and 30 μm or less. A diameter of the second nozzle N2 is, for example, 30 μm or more and 50 μm or less.

As described above, the nozzle plate 37 includes the first layer 371 composed of polycrystalline silicon, the substrate 372 as the “second layer” composed of silicon, and the insulating film 373 provided between the first layer 371 and the substrate 372. The first layer 371 includes the first nozzle N1. The substrate 372 includes the second nozzle N2 that penetrates the first nozzle N1. The second nozzle N2 penetrates the first nozzle N1 through the boundary portion N3 that is an opening of the insulating film 373.

By constituting the first layer 371 corresponding to the first nozzle N1 with polycrystalline silicon, the first layer 371 can be formed by film formation, and the thickness of the first layer 371 can be controlled with high accuracy. Therefore, the length L1, that is, the stroke length, which is a nozzle length of the first nozzle N1, can be controlled with high accuracy. As described above, as compared with a case in which the first nozzle N1 and the second nozzle N2 are formed from one silicon substrate, the length L1 of the first nozzle N1 can be controlled with high accuracy. In addition, as will be described later, by using the insulating film 373 as an etching stopper layer, the length L1 of the first nozzle N1 can be controlled with high accuracy. Therefore, it is easy to realize the length L1 of the first nozzle N1 that is ideal, and individual differences in the length L1 of the first nozzle N1 can be reduced. Since the length L1 of the first nozzle N1 that is ideal can be realized, a reduction in discharging performance can be suppressed.

### 1-5. Manufacturing Method of Nozzle Plate 37

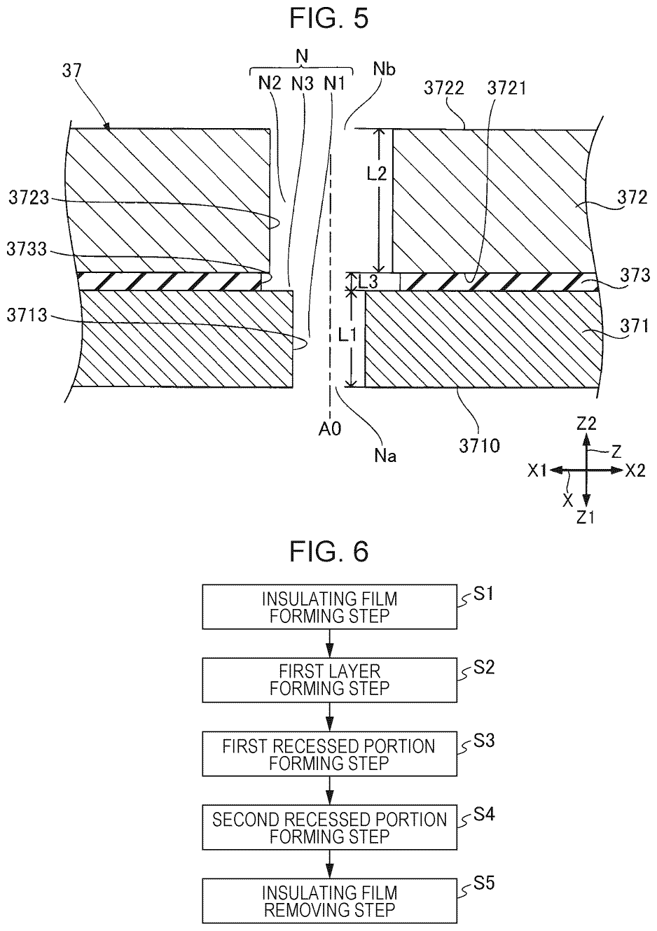

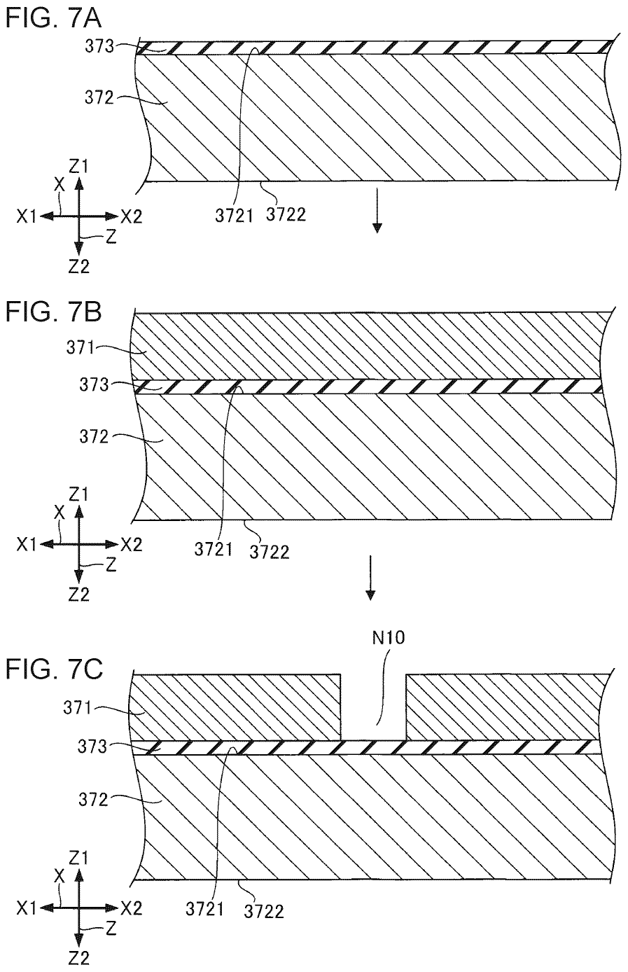

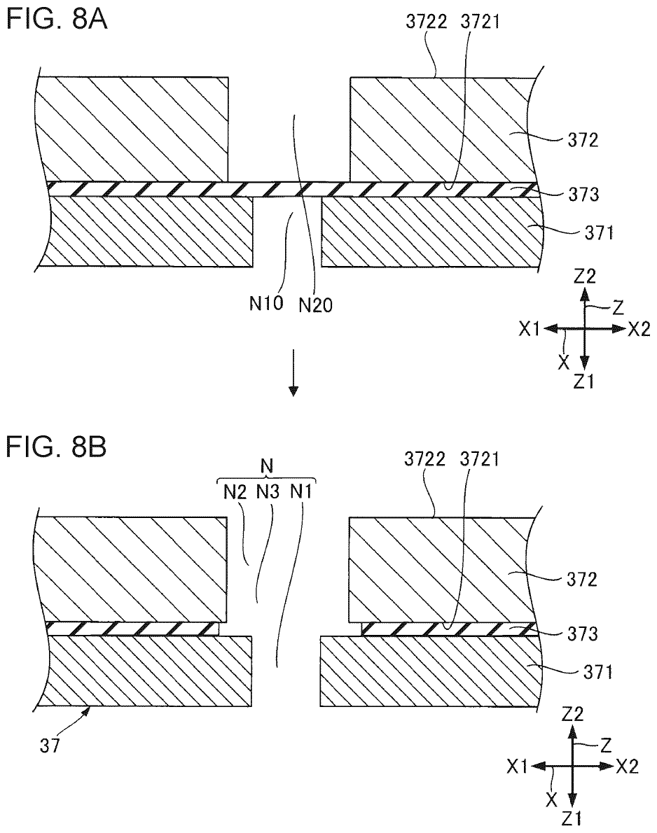

FIG. 6 is a diagram showing a flow of a manufacturing method of the nozzle plate 37 according to the first embodiment. FIGS. 7 and 8 are diagrams for describing the manufacturing method of the nozzle plate 37 of FIG. 6.

As shown in FIG. 6, the manufacturing method of the nozzle plate 37 includes an insulating film forming step S1, a first layer film forming step S2, a first recessed portion forming step S3, a second recessed portion forming step S4, and an insulating film removing step S5.

First, the substrate 372 is prepared before each step. Specifically, the substrate 372 composed of silicon is prepared. More specifically, the substrate 372 composed of single crystal silicon is prepared.

As shown in FIG. 7A, in the insulating film forming step S1, the insulating film 373 is formed on the first surface 3721 of the substrate 372. The insulating film 373 is formed on the first surface 3721 by, for example, an atomic layer deposition (ALD) method using an insulating material such as silicon oxide.

In addition, in the insulating film forming step S1, the insulating film 373 may be formed by thermally oxidizing a part of the substrate 372. By forming the insulating film 373 by thermal oxidation, the process can be simplified as compared to a case in which the insulating film 373 is formed by film formation. When the insulating film 373 is formed by thermally oxidizing a part of the substrate 372, this may also be expressed as forming the insulating film 373 at the first surface 3721.

As shown FIG. 7B, in the first layer film forming step S2, the first layer 371 is formed on the insulating film 373 by deposition. The deposition is a technique of depositing atoms or molecules to form a thin film on the insulating layer. Examples of the film formation include a chemical vapor deposition (CVD) method including an ALD method, a vacuum vapor deposition method, and a sputtering method. The first layer 371 is composed of a material different from a material constituting the substrate 372.

As shown in FIG. 7C, in the first recessed portion forming step S3, a first recessed portion N10 that is the first nozzle N1 is formed. The first recessed portion N10 is a wall surface constituting a hole formed in the first layer 371, in which a bottom surface is the insulating film 373 and a side surface is an inner wall surface 3713 of the first layer 371. The first recessed portion N10 has a cylindrical shape. For example, the first recessed portion N10 is formed by isotropic etching using a Bosch process. For the etching, for example, a fluorine-based etchant is used.

As shown FIG. 8A, in the second recessed portion forming step S4, a second recessed portion N20 that is the second nozzle N2 is formed in the substrate 372. The second recessed portion N20 is formed by etching from the second surface 3722 of the substrate 372 on a side opposite to the first surface 3721. The second recessed portion N20 is formed by isotropic etching. For the etching, for example, a fluorine-based etchant is used. The second recessed portion N20 is a wall surface constituting a hole formed in the substrate 372, in which a bottom surface is the insulating film 373 and a side surface is an inner wall surface 3723 of the substrate 372. In addition, the second recessed portion N20 has a cylindrical shape. A diameter of the second recessed portion N20 is larger than a diameter of the first recessed portion N10. In addition, before the second recessed portion N20 is formed, the substrate 372 may be processed to have a thickness corresponding to the length L2 of the second nozzle N2 by polishing or the like.

As shown FIG. 8B, in the insulating film removing step S5, a part of the insulating film 373 positioned at the bottom surface of the first recessed portion N10 and at the bottom surface of the second recessed portion N20 is removed, thereby forming an opening of the insulating film 373 through which the first recessed portion N10 and the second recessed portion N20 communicate with each other. The partial removal of the insulating film 373 is performed by etching. For the etching, for example, a fluorine-based etchant is used. In addition, due to over-etching in the etching, a diameter of the insulating film 373 is larger than a diameter of the first recessed portion N10 and a diameter of the second recessed portion N20. However, the diameter of the insulating film 373 may be the same as any one of the diameter of the second recessed portion N20 or the diameter of the first recessed portion N10.

After the above steps, a nozzle N including the first nozzle N1 consisting of the first recessed portion N10, the second nozzle N2 consisting of the second recessed portion N20, and the boundary portion N3 is formed.

As described above, the manufacturing method of the liquid discharge head 3 includes the insulating film forming step S1, the first layer film forming step S2, and the first recessed portion forming step S3. In the insulating film forming step S1, the insulating film 373 is formed. In the first layer film forming step S2, the first layer 371 composed of a material different from a material constituting the substrate 372 is formed on the insulating film 373 by deposition. In the first recessed portion forming step S3, in the first layer 371, the first recessed portion N10 that serves as the first nozzle N1 and that has the bottom surface of the insulating film 373 is formed.

In the first layer film forming step S2, the first layer 371 corresponding to the first nozzle N1 is formed on the insulating film 373 by deposition, so that a film thickness of the first layer 371 can be controlled with high accuracy. Therefore, as compared with a case in which the first nozzle N1 and the second nozzle N2 are formed from one silicon substrate as in the related art, a depth of the first recessed portion N10 can be controlled with high accuracy. In addition, in the first recessed portion forming step S3, when the first recessed portion N10 is formed, the insulating film 373 can be used as an etching stopper layer. Therefore, the depth of the first recessed portion N10 can be controlled with high accuracy. Therefore, it is easy to realize the length L1 of the first nozzle N1 that is ideal, and individual differences in the length L1 of the first nozzle N1 can be reduced. Since the length L1 of the first nozzle N1 that is ideal can be realized, a reduction in discharging performance can be suppressed.

In addition, it is preferable that the first layer 371 is composed of polycrystalline silicon. By constituting the first layer 371 with polycrystalline silicon, the linear expansion coefficient of the first layer 371 and the substrate 372 can be made the same or close to each other. Therefore, it is possible to suppress the first layer 371 and the substrate 372 from being peeling off when the temperature of the nozzle plate 37 changes. In addition, since polycrystalline silicon can be formed into a film with high accuracy as compared with other materials, it is possible to easily suppress individual differences in the film thickness of the first layer 371.

In addition, it is preferable that a linear expansion coefficient X of the first layer 371 satisfies Expression (1) when a linear expansion coefficient Y of the substrate 372 is defined.

$$\vert X - Y \vert < 1. \times {10}^{- 6} \qquad ( 1 )$$

By satisfying the above relationship, the linear expansion coefficient X and Y can effectively suppress the first layer 371 and the substrate 372 from peeling off when the temperature changes. The linear expansion coefficients X and Y may not satisfy the above relationship.

Each first layer 371 composed of polycrystalline silicon, amorphous silicon, aluminum oxide (Al₂O₃), silicon carbide (SiC), gallium nitride (GaN), or polyimide satisfies Expression (1). The linear expansion coefficient of the substrate 372 composed of silicon is approximately 2.6×10⁻⁶. When the first layer 371 is composed of polycrystalline silicon, the linear expansion coefficient of the first layer 371 is approximately 2.6×10⁻⁶.

In addition, the linear expansion coefficient of the first layer 371 can be adjusted by adjusting a grain boundary depending on conditions of the CVD method when the first layer 371 is formed by the CVD method. Therefore, from the viewpoint of controlling the film thickness with high accuracy, it is particularly preferable that the first layer 371 is formed by the CVD method.

In addition, it is preferable that a Vickers hardness of the first layer 371 is higher than a Vickers hardness of the substrate 372. By making the Vickers hardness of the first layer 371 higher than the Vickers hardness of the substrate 372, the abrasion resistance of the nozzle surface 3710 can be improved. Therefore, a lifespan of the nozzle plate 37 can be extended. The Vickers hardness of the first layer 371 may be equal to or lower than the Vickers hardness of the substrate 372.

It is preferable that a Young's modulus of the first layer 371 is higher than a Young's modulus of the substrate 372. By making the Young's modulus of the first layer 371 higher than the Young's modulus of the substrate 372, occurrence of crosstalk can be suppressed.

The Young's modulus of the first layer 371 may be equal to or lower than the Young's modulus of the substrate 372. In addition, the Young's modulus of the substrate 372 composed of silicon is approximately 130 GPa or more and 185 GPa or less. When the first layer 371 is composed of polycrystalline silicon, the Young's modulus of the first layer 371 is approximately 150 GPa or more and 170 GPa or less.

In addition, it is preferable that the first recessed portion N10 is formed by a Bosch process in the first recessed portion forming step S3. By forming the first recessed portion N10 by the Bosch process, the length L1 of the first nozzle N1 can be controlled with high accuracy.

In addition, the manufacturing method of the liquid discharge head 3 includes the second recessed portion forming step S4 and the insulating film removing step S5. By including the steps, a so-called two-stage nozzle can be formed. Therefore, the discharging performance of the nozzle N can be increased as compared with a single-stage nozzle.

In addition, in a configuration in which the insulating film 373 is not provided as in the related art, when the second nozzle N2 is formed after the first nozzle N1 is formed, the first nozzle N1 may be excessively etched due to an error in an etching rate of the second nozzle N2. In the present manufacturing method, since the insulating film 373 is provided, the first nozzle N1 is not excessively etched, and the length L1 of the first nozzle N1 can be controlled with high accuracy.

### 2. Second Embodiment

A second embodiment will be described. In each of the following examples, the elements having the same functions as those of the first embodiment will be denoted by the same reference numerals used in the description of the first embodiment, and detailed description thereof will be omitted as appropriate.

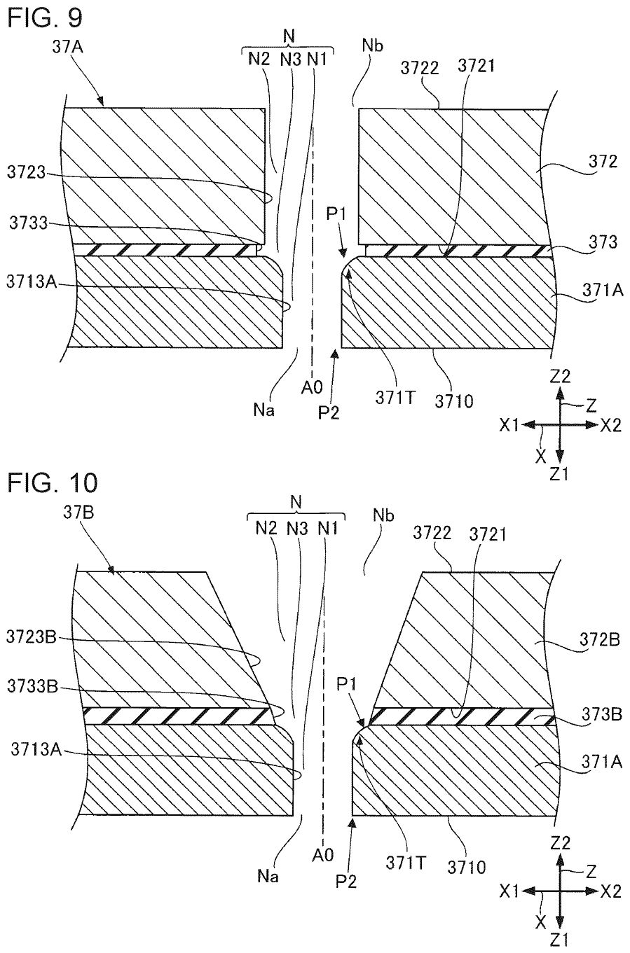

FIG. 9 is a cross-sectional view showing a nozzle N of a nozzle plate 37A according to the second embodiment. As shown in FIG. 9, a bottom surface portion 371T that is an end part of the inner wall surface 3713B of the first layer 371 constituting the first nozzle N1 on the insulating film 373 side has a rounded shape in which a cross-sectional area gradually increases toward the second nozzle N2. Therefore, in the first nozzle N1, when a position close to the insulating film 373 is defined as a first position P1 and a position farther from the insulating film 373 than the first position P1 is defined as a second position P2, a diameter at the first position P1 is larger than a diameter at the second position P2. In the example shown in the drawing, the first position P1 is an end part of the first nozzle N1 on the insulating film 373 side, and the second position P2 is an end part of the first nozzle N1 on a side opposite to the insulating film 373.

By making the diameter at the first position P1 larger than the diameter at the second position P2, it is possible to reduce the ease of air bubble pull-in due to the inductance ratio between the first nozzle N1 and the second nozzle N2 at the end part of the first nozzle N1 on the insulating film 373 side.

In the present embodiment, in the first recessed portion forming step S3, the bottom surface portion 371T of the first recessed portion N10 is over-etched. As a result, the bottom surface portion 371T has a rounded shape in which the cross-sectional area gradually increases toward the second nozzle N2. Therefore, the diameter at the first position P1 can be made larger than the diameter at the second position P2. Therefore, in the bottom surface portion 371T of the first nozzle N1, the ease of air bubble pull-in into the ink of the first nozzle N1 due to the inductance ratio between the first nozzle N1 and the second nozzle N2 can be reduced.

### 3. Third Embodiment

The third embodiment will be described. In each of the following examples, the elements having the same functions as those of the second embodiment will be denoted by the same reference numerals used in the description of the second embodiment, and detailed description thereof will be omitted as appropriate.

FIG. 10 is a cross-sectional view showing a nozzle N of a nozzle plate 37B according to the third embodiment. As shown in FIG. 10, in a substrate 372B of the nozzle plate 37B, a diameter of the second nozzle N2 decreases toward the first nozzle N1. That is, the second nozzle N2 has a tapered shape that tapers toward the first nozzle N1. By making the second nozzle N2 tapered, the ease of air bubble pull-in due to the inductance ratio between the first nozzle N1 and the second nozzle N2 can be reduced as compared to a case in which the second nozzle N2 has a cylindrical shape.

In the present embodiment, in the second recessed portion forming step S4, a tapered shape in which a diameter decreases toward the first recessed portion N10 is formed at an inner wall surface 3723B of the second recessed portion N20. As a result, as described above, the second nozzle N2 is formed in a tapered shape. Therefore, the ease of air bubble pull-in due to the inductance ratio between the first nozzle N1 and the second nozzle N2 can be reduced. In this case, an inner wall surface 3733B of the insulating film 373B is also formed in a tapered shape, but the inner wall surface 3733B may have a cylindrical shape.

As in the first embodiment, in the present embodiment, it is preferable that the first recessed portion N10 is formed by the Bosch process in the first recessed portion forming step S3. On the other hand, in the present embodiment, it is preferable that the second recessed portion N20 is formed by anisotropic etching in the second recessed portion forming step S4.

By forming the first recessed portion N10 by the Bosch process, as in the first embodiment, the length L1 of the first nozzle N1 can be controlled with high accuracy. In addition, in the present embodiment, by forming the second recessed portion N20 by anisotropic etching, the second nozzle N2 can be formed in a tapered shape. Therefore, the ease of air bubble pull-in due to the inductance ratio between the first nozzle N1 and the second nozzle N2 can be reduced.

### 4. Modification Examples

It is possible to modify the above-exemplified embodiments in various ways. Specific embodiments of modifications that are applicable to the above-described embodiments are shown below. It is possible to appropriately combine two or more embodiments selected from the following examples in a range that is not mutually contradictory.

The “liquid discharge head” may be a circulation type head having a so-called circulation flow path.

The “liquid discharge apparatus” can be adopted in various devices, such as a facsimile machine and a copying machine, in addition to a device dedicated to printing. Use of the liquid discharge apparatus is not limited to printing. For example, a liquid discharge apparatus that discharges a solution of a coloring material is used as a manufacturing device that forms a color filter of a display device such as a liquid crystal display panel. In addition, a liquid discharge apparatus that discharges a solution of a conductive material is used as a manufacturing apparatus for forming wiring and electrodes on a wiring substrate. In addition, a liquid discharge apparatus that discharges a solution of an organic substance related to a living body is used as a manufacturing apparatus for manufacturing a biochip, for example.

The “second recessed portion N20” may be provided not to form the “second nozzle N2” but to form a communication path that communicates with the first nozzle N1 and the pressure chamber C1 or a part of the pressure chamber C1.

The present disclosure was described above based on preferred embodiments, but the present disclosure is not limited to the above embodiments. In addition, it is possible to replace the configuration of each part of the present disclosure with any configuration that exerts the same function as the above embodiment, and to add any configuration.

What is claimed is:

1. A manufacturing method of a liquid discharge head, the method comprising:
forming an insulating film at a first surface of a substrate formed of single crystal silicon;
forming a first layer formed of polycrystalline silicon on the insulating film by deposition; and
forming, at the first layer, a first recessed portion that serves as a first nozzle, the first recessed portion having a bottom surface that is the insulating film.

2. The manufacturing method of a liquid discharge head according to claim 1, wherein
when a linear expansion coefficient of the substrate is defined as Y, a linear expansion coefficient X of the first layer satisfies Expression (1),
$$\vert X - Y \vert < 1. \times 10 \hat{} ( - 6 ) . \qquad ( 1 )$$

3. The manufacturing method of a liquid discharge head according to claim 1, wherein
a Vickers hardness of the first layer is higher than a Vickers hardness of the substrate.

4. The manufacturing method of a liquid discharge head according to claim 1, wherein
a Young's modulus of the first layer is higher than a Young's modulus of the substrate.

5. The manufacturing method of a liquid discharge head according to claim 1, wherein
in the forming of the insulating film, the insulating film is formed by thermally oxidizing the first surface of the substrate.

6. The manufacturing method of a liquid discharge head according to claim 1, wherein
in the forming of the first recessed portion, a bottom surface portion of the first recessed portion is over-etched.

7. The manufacturing method of a liquid discharge head according to claim 1, further comprising:
forming, at a second surface that is an opposite side of the first surface of the substrate, a second recessed portion that is a second nozzle having a diameter larger than a diameter of the first nozzle, the second recessed portion having a bottom surface that is the insulating film; and
removing the insulating film positioned at the bottom surface of the first recessed portion and at the bottom surface of the second recessed portion, thereby forming an opening of the insulating film through which the first recessed portion and the second recessed portion communicate with each other.

8. The manufacturing method of a liquid discharge head according to claim 7, wherein
in the forming of the second recessed portion, a tapered shape in which a diameter decreases toward the first recessed portion is formed at an inner wall surface of the second recessed portion.

9. The manufacturing method of a liquid discharge head according to claim 8, wherein
in the forming of the first recessed portion, the first recessed portion is formed by a Bosch process, and in the forming of the second recessed portion, the second recessed portion is formed by anisotropic etching.

10. A liquid discharge head comprising:
a first layer formed of polycrystalline silicon;
a second layer formed of single crystal silicon;
an insulating film provided between the first layer and the second layer;
a first nozzle disposed at the first layer; and
a second nozzle disposed at the second layer, the second nozzle penetrating the first nozzle through an opening of the insulating film.

11. The liquid discharge head according to claim 10, wherein
in the first nozzle, when a position close to the insulating film is defined as a first position and a position farther from the insulating film than the first position is defined as a second position, a diameter at the first position is larger than a diameter at the second position.

12. The liquid discharge head according to claim 10, wherein
a diameter of the second nozzle decreases toward the first nozzle.
